(19) United States
(12) Patent Application Publication
(10) Pub. No.: US 2014/0160095 A1
(43) Pub. Date: Jun. 12, 2014

(54) Backlight Module and Switching Method thereof

(71) Applicant: NOVATEK MICROELECTRONICS CORP., Hsin-Chu (TW)

(72) Inventors: Kuei-Chung Chang, Hsinchu County (TW); Hsien-Wen Lo, Hsinchu County (TW); Chih-Cheng Chang, Hsinchu County (TW)

(73) Assignee: NOVATEK MICROELECTRONICS CORP., Hsin-Chu (TW)

(21) Appl. No.: 13/964,113

(22) Filed: Aug. 12, 2013

(30) Foreign Application Priority Data
Dec. 10, 2012 (TW) 101146425

(51) Int. Cl. G09G 3/34

(52) U.S. Cl. CPC G09G 3/34
USPC 345/204; 345/102

(57) ABSTRACT

A backlight module for a display device includes a clock generation module for generating a clock signal, a control module for generating a control signal and a selection control signal, a selection module coupled to the clock generation module and the control module for generating a selection result according to the clock signal and the control signal, and an output module coupled to the selection module for outputting the selection result according to the selection control signal, wherein the selection result controls the display device to be operated in a normal backlight mode, a transition mode or a flashing backlight mode.

### BACKGROUND OF THE INVENTION

1. Field of the Invention

The present invention relates to a backlight module and a switching method thereof, and more particularly, to a backlight module and a switching method thereof to smoothly switch a display device operated between a normal backlight mode and a flashing backlight mode.

2. Description of the Prior Art

Consumers can arbitrarily select various size display devices equipped with different functions, and display device suppliers have been working on providing better output efficiency as well as higher display resolution of new products to satisfy different user requirements. For the small-size display devices utilizing flashing backlight sources or display devices utilizing single light sources, the display devices can be operated in the normal backlight mode as well as in the flashing backlight mode. In detail, display pictures of the display device comprise a plurality of frame signals to be sequentially displayed on the display device within a fixed period. If the display device is operated in the normal backlight mode, each of the frame signals is periodically operated to be turned on/off without interruption. If the display device is operated in the flashing backlight mode, each of the frame signals is periodically operated to be turned on and turned off within a partial of the fixed period, and is operated to be turned off within the other of the fixed period. However, if a user directly operates the display device being switched between the normal backlight mode and the flashing backlight mode, the user will easily feel brightness changes of the display pictures displayed on the display device considering the persistence of vision, and becomes visually sick while observing the display pictures, which may decrease corresponding observing quality of the user as well and limit the application range of the small-size display devices and the ones utilizing the flashing backlight sources.

Therefore, it has become an important issue to provide an efficient backlight module and a switching method thereof under different brightness of the small-size display devices and the ones utilizing the flashing backlight sources, so as to prevent the user from feeling visually sick while switching the display device between the normal backlight mode and the flashing backlight mode.

### SUMMARY OF THE INVENTION

It is therefore an objective of the invention to provide a backlight module and a switching method thereof to switch the display device between the normal backlight mode, the transition mode and the flashing backlight mode.

An embodiment of the invention discloses a backlight module for a display device comprising a clock generation module for generating a clock signal, a control module for generating a control signal and a selection control signal, a selection module coupled to the clock generation module and the control module for generating a selection result according to the clock signal and the control signal, and an output module coupled to the selection module for outputting the selection result according to the selection control signal, wherein the selection result controls the display device is to be operated in a normal backlight mode, a transition mode or a flashing backlight mode.

An embodiment of the invention also discloses another switch method for a backlight module coupled to a display device. The switch method comprises generating a clock signal, generating a control signal and a selection control signal, generating a selection result according to the clock signal and the control signal, and outputting the selection result according to the selection control signal, wherein the selection result controls the display device to be operated in a normal backlight mode, a transition mode or a flashing backlight mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a backlight module according to an embodiment of the invention.

FIG. 2 illustrates a detailed schematic diagram of the backlight module and the selection module shown in FIG. 1 according to an embodiment of the invention.

FIG. 3 illustrates a schematic diagram of switching the display device between the normal backlight mode, the transition mode or the flashing backlight mode according to an embodiment of the invention.

FIG. 4 illustrates a schematic diagram of switching the display picture from the transition mode to the flashing backlight mode to satisfy a predetermined condition according to an embodiment of the invention.

FIG. 5 illustrates a schematic diagram of another frame signal in the flashing backlight mode according to an embodiment of the invention.

FIG. 6 illustrates a schematic diagram of another backlight module according to an embodiment of the invention.

FIG. 7 illustrates a schematic diagram of a series of frame signals operated in a delay period to be switched from the normal backlight mode via the transition mode to the flashing backlight mode according to an embodiment of the invention.

FIG. 8 illustrates a series of frame signals operated in the delay period to be switched from the flashing backlight mode via the transition mode to the normal backlight mode according to an embodiment of the invention.

FIG. 9 illustrates a flow chart of a backlight module switching process according to an embodiment of the invention.

FIG. 10 illustrates a flow chart of another backlight module switching process according to an embodiment of the invention.

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claims is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

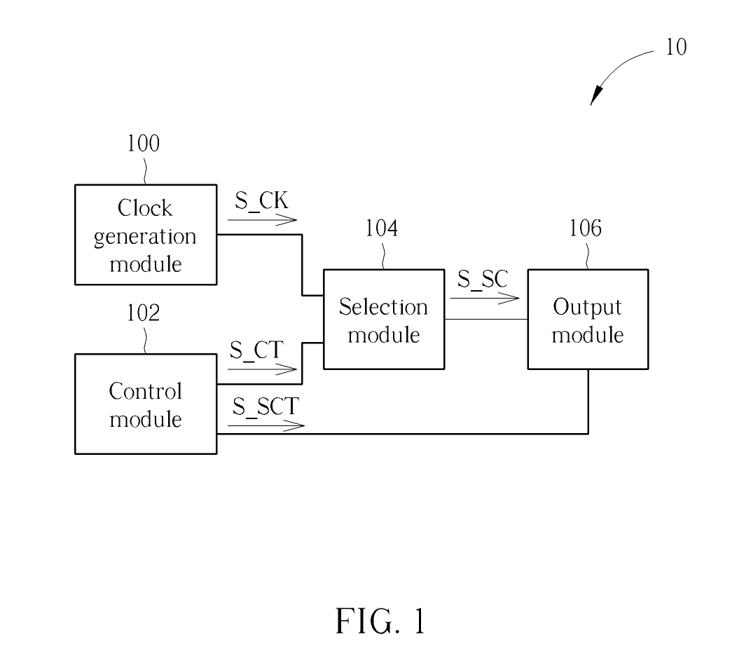

Please refer to FIG. 1, which illustrates a schematic diagram of a backlight module 10 according to an embodiment of the invention, wherein the backlight module 10 is installed in a display device (not shown in the figure) or the backlight module 10 is coupled to the display device to correspondingly control an output result of the display device. As shown in FIG. 1, the backlight module 10 comprises a clock generation module 100, a control module 102, a selection module 104 and an output module 106. In detail, the clock generation module 100 is utilized to generate a clock signal S_CK. The control module 102 is utilized to generate a control signal S_CT and a selection control signal S_SCT. The selection module 104 is coupled to the clock generation module 100 and the control module 102 to receive the clock signal S_CK and the control signal S_CT, so as to output a selection result S_SC to the output module 106. The output module 106 is coupled to the selection module 104 and the control module 102 to receive the selection result S_SC and the selection control signal S_SCT, so as to output the selection result S_SC to the display device, such that the display device can be switched between a normal backlight mode, a transition mode or a flashing backlight mode.

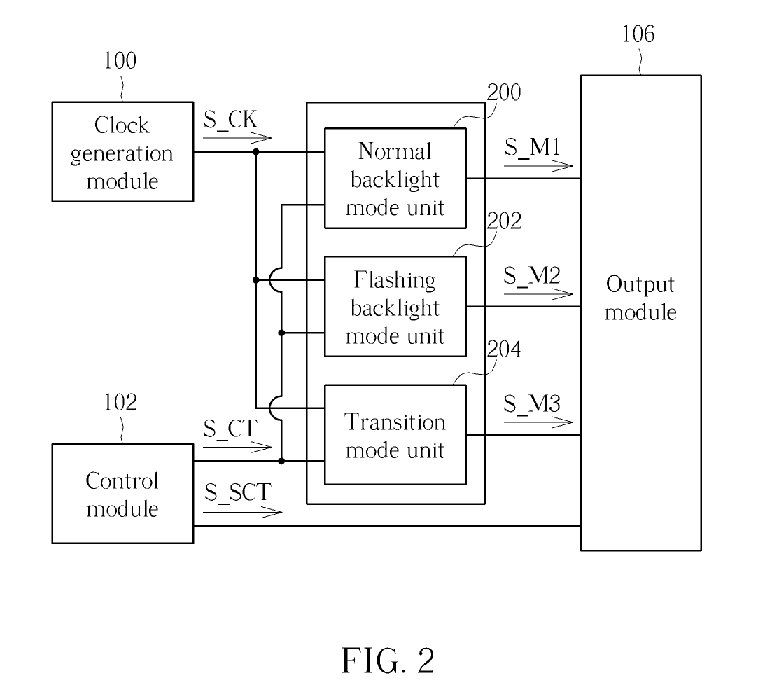

Please refer to FIG. 2, which illustrates a detailed schematic diagram of the backlight module 10 and the selection module 104 shown in FIG. 1 according to an embodiment of the invention. As shown in FIG. 2, the selection module 104 further comprises a normal backlight mode unit 200, a flashing backlight mode unit 202 and a transition mode unit 204 to receive the clock signal S_CK and the control signal S_CT, respectively, so as to generate a normal backlight mode signal S_M1, a flashing backlight mode signal S_M2 and a transition mode signal S_M3. The output module 106 receives the normal backlight mode signal S_M1, the flashing backlight mode signal S_M2 and the transition mode signal S_M3, and accordingly, outputs one of the normal backlight mode signal S_M1, the flashing backlight mode signal S_M2 and the transition mode signal S_M3 according to the selection control signal S_SCT to control a display way of the display device.

Simply, the embodiment of the invention utilizes the control module 102 to generate the control signal S_CT and the selection control signal S_SCT to correspondingly control the selection module 104, and utilizes the output module 106 to output one of the normal backlight mode signal S_M1, the flashing backlight mode signal S_M2 and the transition mode signal S_M3 generated by the selection module 104, so as to switch the display device between the normal backlight mode, the transition mode and the flashing backlight mode. In comparison with the prior art switching the display device between the normal backlight mode or the flashing backlight mode, the embodiment of the invention further adds the transition mode between the normal backlight mode and the flashing backlight mode. Also, the transition mode corresponds to a transition operation period, and the display device is changed from the normal backlight mode via the transition mode to the flashing backlight mode during the transition operation period, such that the user can be prevented from feeling visually sick while switching the display device accompanying with the brightness changes of the display pictures. Certainly, the backlight module 10 can also be utilized to control the display device from the flashing backlight mode via the transition mode to the normal backlight mode, which is also in the scope of the invention.

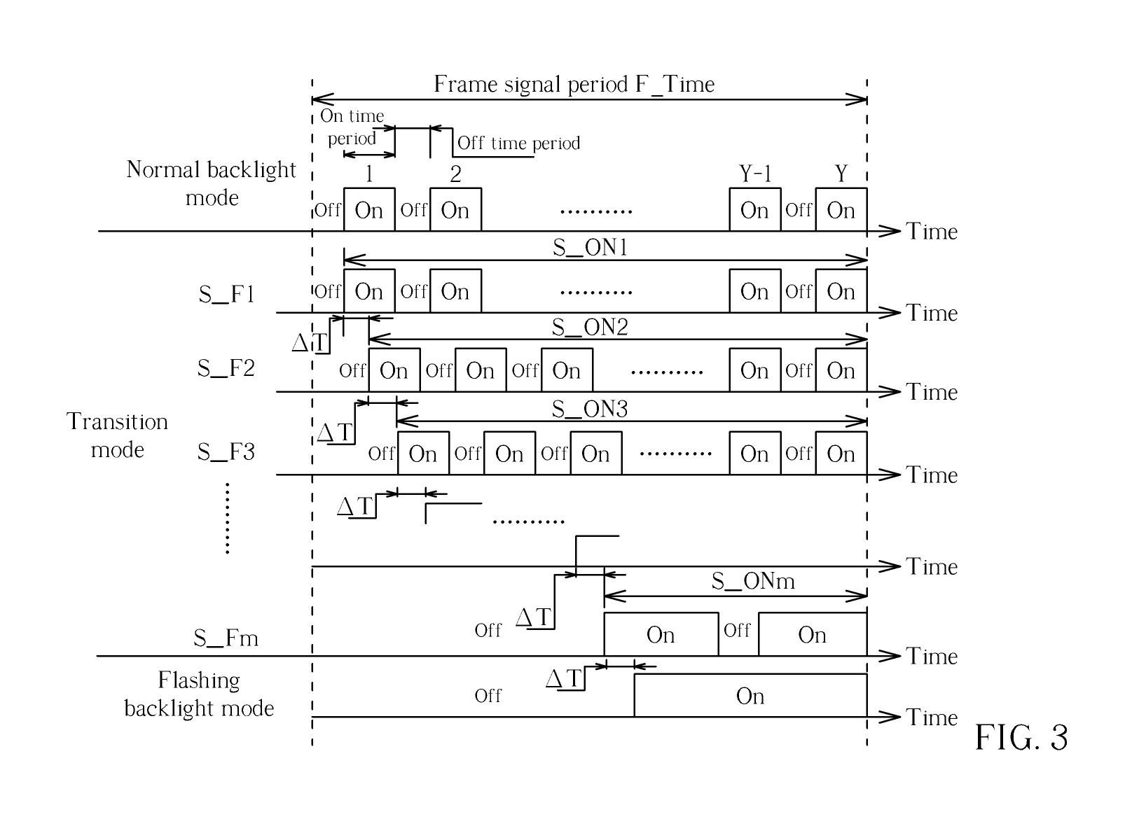

Please refer to FIG. 3, which illustrates a schematic diagram of switching the display device between the normal backlight mode, the transition mode or the flashing backlight mode according to an embodiment of the invention. Noticeably, the embodiment of the invention has the display pictures comprising a plurality of frame signals, and, for clearer description, only one of the plurality of frame signals is illustrated in FIG. 3 to demonstrate how the display device is switched between the normal backlight mode, the transition mode or the flashing backlight mode, wherein each of the plurality of frame signals corresponds to a frame signal period F_Time. As shown in FIG. 3, when the display device is operated in the normal backlight mode, it is periodically operated to have turned on/off operations within the frame signal period F_Time. Supposed that one turning on operation as well as one turning off operation can be regarded as an on time operation, there exists Y times of on time operations in the normal backlight mode. Besides, one turning on operation corresponds to an on time period ON_Time and one turning off operation corresponds to an off time period OFF_Time. Under such circumstances, a brightness level of the display device in the normal backlight mode can be represented via a duty cycle, i.e.

$$Duty cycle ( \% ) = \frac{( ON\_Time )}{( ON\_Time + OFF\_Time )} ,$$

and a number of the on time operation
can be represented as

$$Y = \frac{( F\_Time )}{( ON\_Time + OFF\_Time )} .$$

Also, the on time period ON_Time can also be represented via the number of the on time operation as well as the duty cycle, i.e.

$$ON\_Time = \frac{( Duty cycle \times F\_Time )}{Y} ,$$

and in the meanwhile, the off time period can be represented as

$$OFF\_Time = \frac{( F\_Time - Y \times ON\_Time )}{Y} .$$

Please continue to refer to FIG. 3. When the display device is operated from the normal backlight mode to the transition mode, an on time duty signal S_ONx can be defined within the frame signal period F_Time, such that the transition mode sequentially generates a plurality of transition stages according to different on time duty signal, and each of the transition stages corresponds to one frame signal. In the embodiment, the transition stage comprises a plurality of transition stages S_F1-S_Fm, each of the plurality of transition stages S_F1-S_Fm corresponds to one of the plurality of on time duty signals S_ON1-S_ONm, respectively, and each of the plurality of on time duty signals is an operational period in the frame signal period F_Time. Specifically, a difference of the two neighboring on time duty signals corresponding to the two neighboring frame signals forms an on time duty signal change ΔT, which can be generated via an arithmetic progression or a geometric progression for correspondingly adjusting the plurality of on time duty signals S_ON1-S_ONm to be longer or shorter, and is not limiting in the scope of the invention. Preferably, if the geometric progression is utilized for generation, the on time duty signal change ΔT can be generated as ΔT=S_ONx×C %,C=1,2,3 . . . ; if the arithmetic progression is utilized for generation, the on time duty signal change ΔT can be generated as ΔT=S_ONx −S_ONx −1. Additionally, the embodiment of the invention further defines a operational range of the on time duty signal change ΔT to be ΔT=S_ON1×(3˜6%), and is not limiting the scope of the invention as well.

Noticeably, when the embodiment of the invention is ready for entering into the transition mode from the normal backlight mode, the user can adaptively choose different values of the on time duty signal change ΔT according to different requirements, to dynamically adjust a number of the plurality of transition stages S_F1-S_Fm. Accordingly, the user can be prevented from feeling visually sick while switching the display pictures displayed on the display device. In other words, after the embodiment of the invention enters into the transition mode, the frame signal of the display picture will sequentially be changed from the transition stage S_F1 to the transition stage S_Fm, wherein the operation period of each on time duty signal S_ONx is gradually decreased in the frame signal period F_Time, and in comparison, a sleeping period subtracting the operation period from the frame signal period F_Time is correspondingly increased. Thus, the display device can be smoothly switched from the normal backlight mode via the transition mode to the flashing backlight mode according to a proper number of the transition stages. Preferably, in the transition mode, a number of the on time operation for the display picture within the frame signal period F_Time is Y_{T} and can be obtained via

$${Y}_{T} = \frac{( F\_Time )}{( ON\_Time + OFF\_Time ) \times S\_ONx} ,$$

the on time period ON_Time can be obtained via

$$ON\_Time = \frac{( Duty cycle \times F\_Time )}{{Y}_{T}} ,$$

and the off time period OFF_Time can be obtained via

$$OFF\_Time = \frac{( S\_ONx - ( {Y}_{T} \times ON\_Time ) )}{( {Y}_{T} - 1 )} .$$

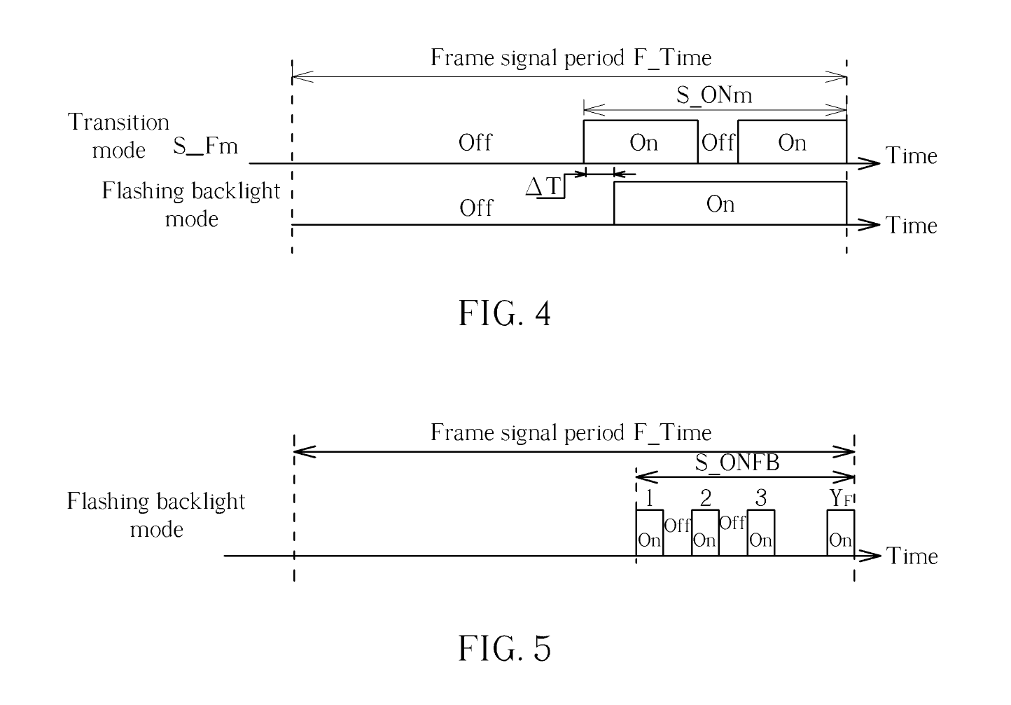

Please refer to FIG. 3 again. When the display device is switched from the transition mode to the flashing backlight mode, the frame signal, within the frame signal period F_Time, is operated via only one on time operation, i.e. being operated via one turning on operation and one turning off operation. Under such circumstances, the on time period ON_Time of the turning on operation as well as the off time period OFF_Time of the turning off operation in the flashing backlight mode are longer than the periods in the normal backlight mode. Please refer to FIG. 4, which illustrates a schematic diagram of switching the display picture from the transition mode to the flashing backlight mode to satisfy a predetermined condition according to an embodiment of the invention, wherein FIG. 4 only depicts the corresponding frame signal from the transition stage S_Fm of the transition mode to the flashing backlight mode. As shown in FIG. 4, when the frame signal of the display picture is switched from the transition stage S_Fm to the flashing backlight mode, a amount of the on time duty signal S_ONm of the transition stage S_Fm is smaller than a amount of the duty cycle timing the frame signal period F_Time to be added with the on time duty signal change ΔT, i.e. the condition is held as S_ONm<Duty cycle×F_Time+ΔT . Accordingly, the output module 106 will switch the display device to be operated between the transition mode and the flashing backlight mode according to whether the mentioned condition is true or not.

Please refer to FIG. 5, which illustrates a schematic diagram of another frame signal in the flashing backlight mode according to an embodiment of the invention. As shown in FIG. 5, the display picture and the corresponding frame signal in the embodiment have a minimum value of the flashing backlight on time duty signal S_ONFB within the frame signal period F_Time, and accordingly, a number of the on time operation as Y_{F} is obtained. Preferably, the on time period ON_Time is obtained via

$$ON\_Time = \frac{( Duty cycle \times F\_Time )}{{Y}_{F}} ,$$

and the off time period OFF_Time is obtained via

$$OFF\_Time = \frac{( S\_ONFB - ( {Y}_{F} \times ON\_Time ) )}{( {Y}_{F} - 1 )}$$

as well. Besides, the on time period ON_Time as well as the off time period OFF_Time can be utilized to represent the flashing backlight on time duty signal S_ONFB as

$$S\_ONFB = \frac{( F\_Time )}{( ON\_Time + OFF\_Time ) \times {Y}_{F}} .$$

When the on time duty signal S_ONx is smaller than the flashing backlight on time duty signal S_ONFB, the display picture is correspondingly switched from the transition mode to the flashing backlight mode, such that the output module 106 is informed to process the switching operation as well. Certainly, those skilled in the art can combine the frame signals shown in FIG. 3 and FIG. 5 to switch the display picture between the normal backlight mode and the flashing backlight mode, so as to choose the proper on time duty signal change ΔT, which is also in the scope of the invention.

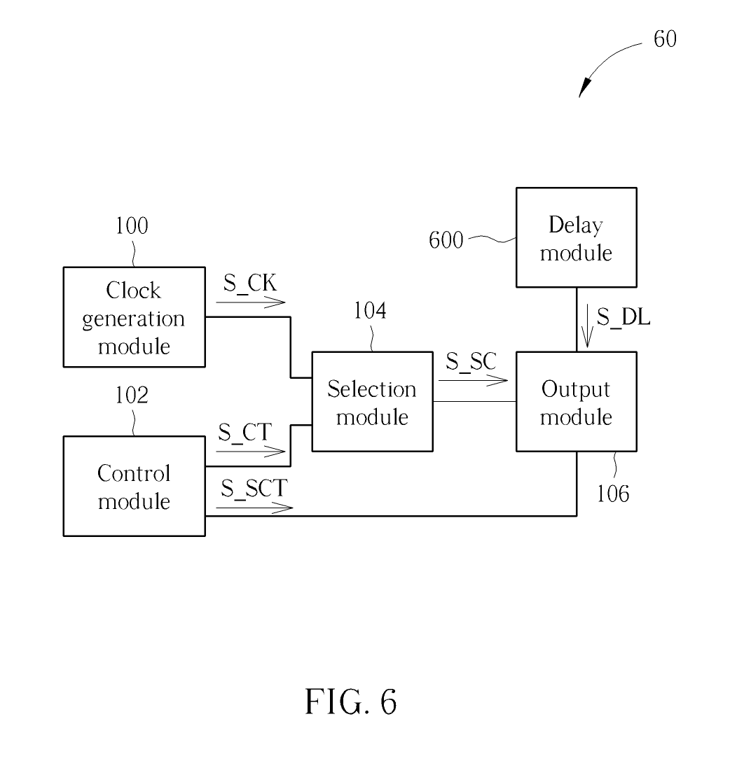

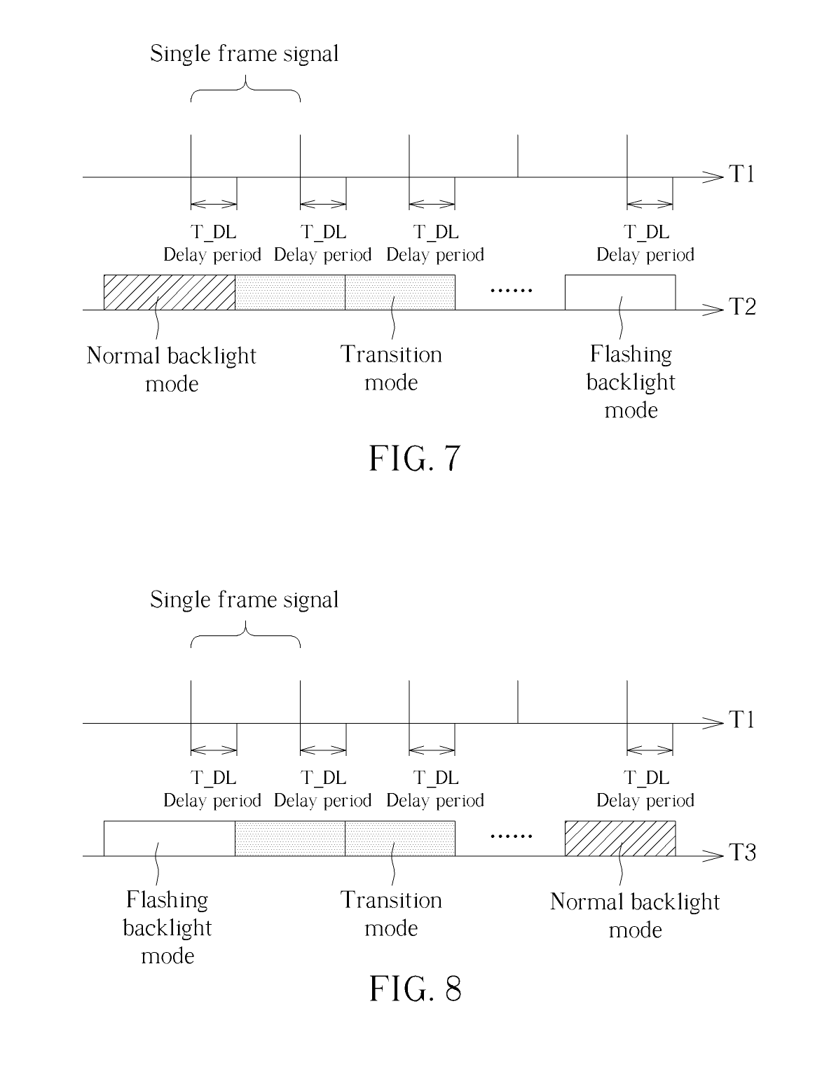

Please refer to FIG. 6, which illustrates a schematic diagram of another backlight module 60 according to an embodiment of the invention. As shown in FIG. 6, the backlight module 60 is similar to the backlight module 10 shown in FIG. 1, and the backlight module 60 further comprises a delay module 600 coupled to the output module 106, and the delay module 600 is utilized to generate a delay signal S_DL to the output module 106, such that the output module 106 can simultaneously utilize the selection control signal S_SCT and the delay signal S_DL as a determination mechanism to output one of the normal backlight mode signal S_M1, the flashing backlight mode signal S_M2 and the transition mode signal S_M3, so as to switch the display device between the normal backlight mode, the transition mode and the flashing backlight mode. Additionally, please refer to FIG. 7 and FIG. 8, wherein FIG. 7 illustrates a schematic diagram of a series of frame signals operated in a delay period to be switched from the normal backlight mode via the transition mode to the flashing backlight mode according to an embodiment of the invention, and FIG. 8 illustrates a series of frame signals operated in the delay period to be switched from the flashing backlight mode via the transition mode to the normal backlight mode according to an embodiment of the invention. As shown in FIG. 7 and FIG. 8, in comparison with an operation period T1 of the original frame signal, the embodiments of the invention have operation periods T2, T3 as being operated in the normal backlight mode, the transition mode or the flashing backlight mode, and the operation periods T2, T3 is delayed a delay period T_DL compared to the operation period T1. Accordingly, the embodiments shown in FIG. 7 and FIG. 8 can comply with a responsive period of liquid crystal materials in the display device to adaptively cooperate with the output module 106 for switching the display picture in the normal backlight mode, in the transition mode or in the flashing backlight mode, so as to prevent the user from easily sensing the switching of the display device.

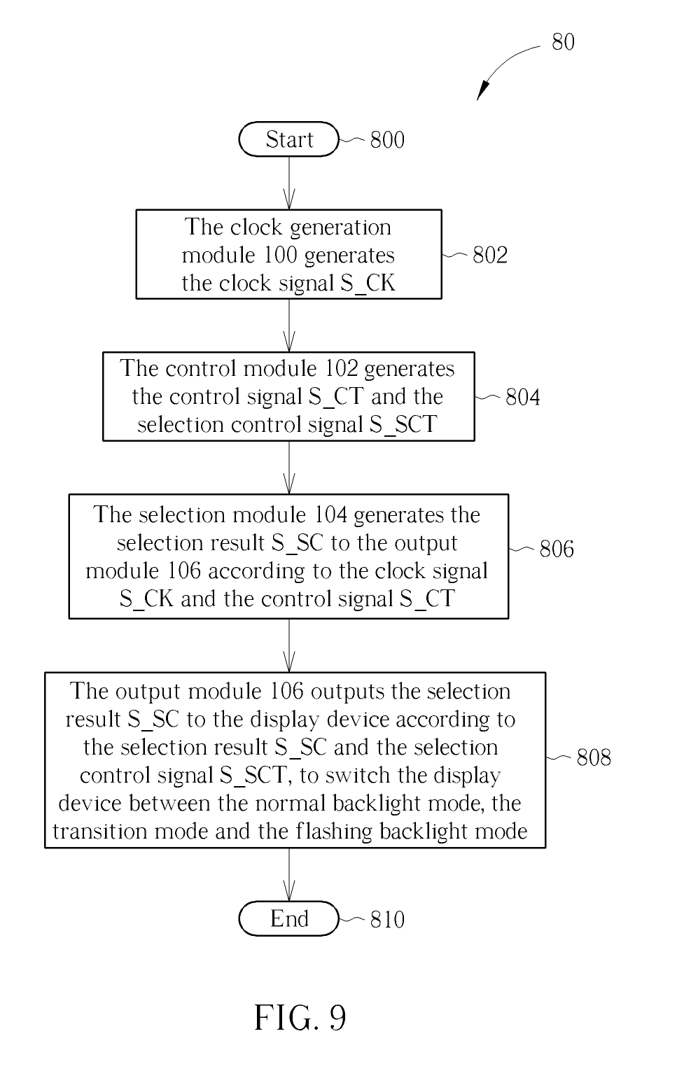

In the embodiment, the switching operation of the backlight module 10 coupled to the display device can be summarized as a backlight module switching process 80, as shown in FIG. 9. The backlight module switching process 80 includes the steps as follows.

Step 800: Start.

Step 802: The clock generation module 100 generates the clock signal S_CK.

Step 804: The control module 102 generates the control signal S_CT and the selection control signal S_SCT.

Step 806: The selection module 104 generates the selection result S_SC to the output module 106 according to the clock signal S_CK and the control signal S_CT.

Step 808: The output module 106 outputs the selection result S_SC to the display device according to the selection result S_SC and the selection control signal S_SCT, to switch the display device between the normal backlight mode, the transition mode and the flashing backlight mode.

Step 810: End.

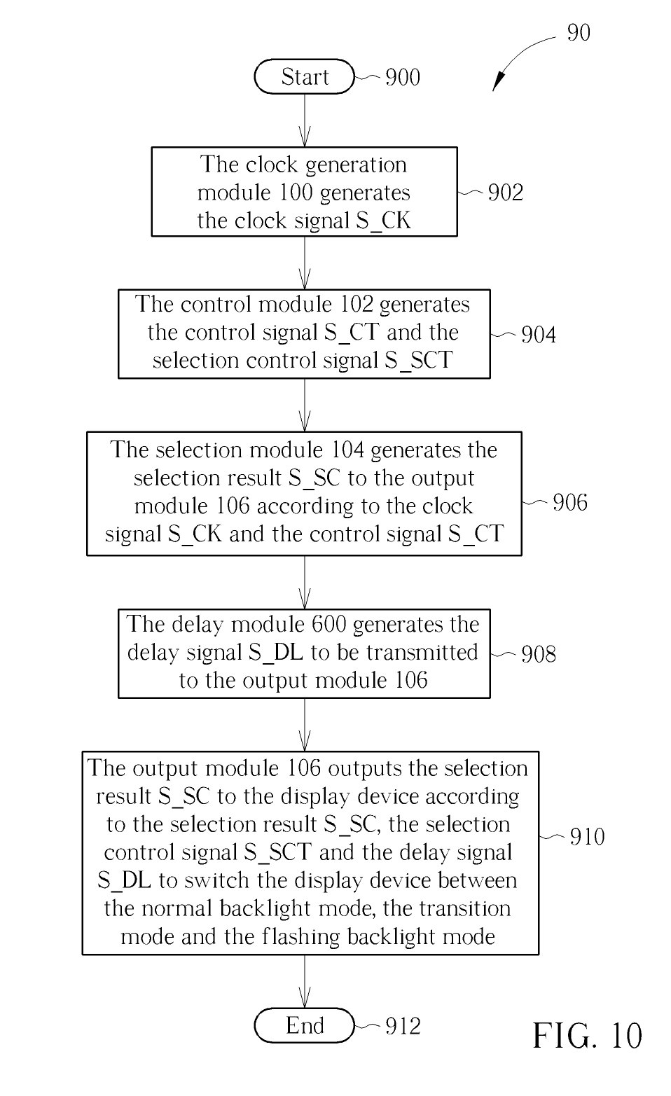

The detailed operations of the backlight module switching process 80 can be understood from the backlight module 10 and related paragraphs for FIG. 1 to FIG. 8, which is not described hereinafter. Besides, another backlight module switching method for the backlight module 60 coupled to the display device can also be summarized as a backlight module switching process 90, as shown in FIG. 10. The backlight module switching process 90 includes the steps as follows.

Step 900: Start.

Step 902: The clock generation module 100 generates the clock signal S_CK.

Step 904: The control module 102 generates the control signal S_CT and the selection control signal S_SCT.

Step 906: The selection module 104 generates the selection result S_SC to the output module 106 according to the clock signal S_CK and the control signal S CT.

Step 908: The delay module 600 generates the delay signal S_DL to be transmitted to the output module 106.

Step 910: The output module 106 outputs the selection result S_SC to the display device according to the selection result S_SC, the selection control signal S_SCT and the delay signal S_DL to switch the display device between the normal backlight mode, the transition mode and the flashing backlight mode.

Step 912: End.

Noticeably, differences between the backlight module switching process 90 and the backlight module switching process 80 are that the backlight module switching process 90 further comprises step 908 for generating the delay signal S_DL to the output module 106 via the delay module 600, and accordingly, step 910 of the backlight module switching process 90 adaptively displays the selection result S_SC on the display device for processing the switching operation of the display device being operated in the normal backlight mode, the transition mode or the flashing backlight mode according to the selection control signal S_SCT and the delay signal S_DL. The detailed operations of the other steps in the backlight module switching process 90 can also be understood from the backlight modules 10, 60 and related paragraphs for FIG. 1 to FIG. 8, which is not described hereinafter.

Moreover, in step 806 or step 906, the normal backlight mode unit 200, the flashing backlight mode unit 202 and the transition mode unit 204 simultaneously utilize the clock signal S_CK and the control signal S_CT to output the selection result S_SC (i.e. the normal backlight mode signal S_M1, the flashing backlight mode signal S_M2 and the transition mode signal S_M3) to the output module 106. The control module 102 also utilizes the control signal S_CT to adjust parameters, such as the frame signal period F_Time, the duty cycle, the on time period ON_Time, the off time period OFF_Time, the on time duty signals S_ON1-S_ONm, the number of the transition stages S_F1-S_Fm, the number of the on time operation Y, Y_{F}, Y_{T} and the on time duty signal change ΔT, of the normal backlight mode unit 200, the flashing backlight mode unit 202 and the transition mode unit 204, so as to output the adjusted selection result S_SC to the output module 106, such that the display picture can be smoothly displayed in the normal backlight mode, the transition mode or the flashing backlight mode. Further, those skilled in the art can adaptively add other adjustment parameters for the small-size display devices and the ones utilizing the flashing backlight sources to prevent the user from sensing visual sickness while switching the display device between the normal backlight mode and the flashing backlight mode, which is also in the scope of the invention.

In summary, the embodiments of the invention provides a backlight module coupled to a display device and a switching method thereof, which adaptively output a selection result of a selection module to switch a display picture of the display device being operated in a normal backlight mode, a transition mode or a flashing backlight mode. Related parameters of different operation modes can be adaptively adjusted, and a delay operation for a responsive period of liquid crystal materials of the display device can be processed as well. Thus, the small-size display devices and the ones utilizing the flashing backlight sources can be smoothly operated and switched between the normal backlight mode and the flashing backlight mode, and accordingly, the user can avoid easily sensing visual sickness while observing the display picture having the brightness change thereof, such that the application range of the small-size display devices and the ones utilizing the flashing backlight sources can be effectively enlarged.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight module for a display device, comprising:
a clock generation module for generating a clock signal;
a control module for generating a control signal and a selection control signal;
a selection module coupled to the clock generation module and the control module for generating a selection result according to the clock signal and the control signal; and
an output module coupled to the selection module for outputting the selection result according to the selection control signal;
wherein the selection result controls the display device to be operated in a normal backlight mode, a transition mode or a flashing backlight mode.

2. The backlight module of claim 1, wherein the selection module further comprises a normal backlight mode unit for generating a normal backlight mode signal to the output module according to the clock signal and the control signal, such that the output module switches the display device to be operated in the normal backlight mode.

3. The backlight module of claim 1, wherein the selection module further comprises a flashing backlight mode unit for generating a flashing backlight mode signal to the output module according to the clock signal and the control signal, such that the output module switches the display device to be operated in the flashing backlight mode.

4. The backlight module of claim 1, wherein the selection module further comprises a transition mode unit for generating a transition mode signal to the output module according to the clock signal and the control signal, such that the output module switches the display device to be operated in the transition mode.

5. The backlight module of claim 1, wherein the selection result further comprises at least a frame signal to be displayed on the display device.

6. The backlight module of claim 1, wherein the transition mode further comprises an on time duty signal to be generated via an arithmetic progression or a geometric progression.

7. The backlight module of claim 6, wherein the transition mode sequentially generates a plurality of transition stages according to the on time duty signal, and each of the plurality of transition stages corresponds to a frame signal.

8. The backlight module of claim 7, wherein the frame signal further comprises a frame signal period, and an operational period of the frame signal period is adjusted according to the on time duty signal.

9. The backlight module of claim 8, wherein when the transition mode sequentially generates the plurality of transition stages, the operational period corresponding to each of a plurality of frame signal periods gradually decreases, such that the display device is switched from the normal backlight mode via the transition mode to the flashing backlight mode.

10. The backlight module of claim 1, further comprising a delay module for generating a delay signal to the output module, to switch the display device between the normal backlight mode, the transition mode and the flashing backlight mode.

11. A switch method for a backlight module coupled to a display device,
the switch method comprising:
generating a clock signal;
generating a control signal and a selection control signal;
generating a selection result according to the clock signal and the control signal; and
outputting the selection result according to the selection control signal;
wherein the selection result controls the display device to be operated in a normal backlight mode, a transition mode or a flashing backlight mode.

12. The switch method of claim 11, wherein the selection result further comprises at least a frame signal to be displayed on the display device.

13. The switch method of claim 11, wherein the transition mode further comprises an on time duty signal to be generated via an arithmetic progression or a geometric progression.

14. The switch method of claim 13, wherein the transition mode sequentially generates a plurality of transition stages according to the on time duty signal, and each of the plurality of transition stages corresponds to a frame signal.

15. The switch method of claim 14, wherein the frame signal further comprises a frame signal period, and an operational period of the frame signal period is adjusted according to the on time duty signal.

16. The switch method of claim 15, wherein when the transition mode sequentially generates the plurality of transition stages, the operational period corresponding to each of a plurality of frame signal periods gradually decreases, such that the display device is switched from the normal backlight mode via the transition mode to the flashing backlight mode.

17. The switch method of claim 11, further generating a delay signal to switch the display device between the normal backlight mode, the transition mode and the flashing backlight mode.
